(19) United States
(12) Patent Application Publication
(10) Pub. No.: US 2004/0007270 A1
(43) Pub. Date: Jan. 15, 2004

(54) Fluid pressure regulator with stabilizer

(76) Inventor: Charles M. Olds, Martindale, TX (US)

Correspondence Address: CHARLES M. OLDS, 695 Kenmoor, S. E., Post Office Box 2567, Grand Rapids, MI, 49501, US

(21) Appl. No.: 10/376,196

(22) Filed: Feb. 27, 2003

Related U.S. Application Data
(60) Provisional application No. 60/359,841, filed on Feb. 27, 2002.

(51) Int. Cl. G05D 16/06

(52) U.S. Cl. 137/505.46

(57) ABSTRACT

A pressure regulator comprising a housing, a pivoting lever, a diaphragm and a stabilizer element. The housing has an inlet port and an outlet port. The pivoting lever selectively covers a section of a passage between the inlet port and the outlet port. The diaphragm is interconnected to the pivoting lever to rotate the lever in reaction to pressure levels in the housing. The stabilizer element is movable with the pivoting lever. The stabilizer element frictionally abuts a portion of the housing as the pivoting lever rotates to thereby stabilize movement of the pivoting lever.

### CROSS-REFERENCE TO RELATED APPLICATION

The present invention claims priority to Provisional Patent Application Serial No. 60/359,841, filed on Feb. 27, 2002 entitled FLUID PRESSURE REGULATOR WITH STABILIZER.

### FIELD OF THE INVENTION AND BACKGROUND

This invention relates to fluid pressure regulators, for example gas pressure regulators, and more particularly to pressure fluctuation stabilizers for such regulators.

Fluid pressure regulators such as gas pressure regulators have long been known and used to provide a regulated flow of gas from a source to a using device, so as to provide a steady pressure at the inlet of the using device and, typically, to reduce the pressure available from the source to an acceptable range for properly operating the using device. A basic and typical such regulator has an inlet for connection to the source and an outlet for connection to the using device, plus a pressure-sensing member such as a diaphragm that operates a throttling valve to control the gas flow from the inlet to the outlet. Usually, there is a loading or biasing means such as an adjustable spring device which acts against the diaphragm to establish a desired preload that in turn causes the throttling valve to allow the desired amount of flow to the outlet. Various mechanisms are or can be used to connect the diaphragm to the throttle valve, a typical such mechanism being a lever that is pivotally mounted within the regulator body such that one end is coupled to the diaphragm and the other end coupled to the throttle valve.

In all such regulators, the resilient loading applied to the diaphragm creates the potential for at least some oscillation in response to operating pressure changes, particularly sudden or large pressure changes, at which time the diaphragm system is subject to at least limited over-shooting and consequent oscillation (hunting) as the system adjusts to the pressure change. This is particularly true in high-pressure gas systems, in which rapid or sudden pressure changes such as those caused, for example, by rapid turn-on or turn-off of the utilizing devices, and the resultant changes in gas demand. Such oscillations or fluctuations are not desirable, and various means are sometimes employed to damp the system components in one way or another so as to reduce its operational resiliency. Some such systems have used flexible baffle-like devices which act as flow stabilizers by partially absorbing sudden flow changes and in effect smoothing the flow of gas to the using device, thus acting as a flexible damper. Friction-inducing devices have also been used, including O-ring type elastomers mounted on or so as to bear against moving internal components of the regulator system or throttle valve linkage to induce a certain amount of friction between the components that tend to damp-out desired fluctuation, thereby stabilizing the diaphragm system-valve linkage operation and, as a result, stabilizing the pressure regulation performance.

Another type of such a stabilizer is shown in U.S. Pat. No. 5,735,306, in which the present inventor is also a named inventor and which is incorporated by reference herein with respect to its general discussion and, to the extent relevant, the general type of stabilizer to which the present invention is directed, with respect to which the present invention provides a meritorious improvement. The device of the '306 patent provided a spring clip member secured inside the regulator body so as to frictionally bear against the pivoting diaphragm lever arm, to thereby reduce rapid fluctuations otherwise transmitted to the throttle valve which would cause undesirable gas flow fluctuations with accompanying pressure variations. A second embodiment of the invention in the '306 patent is in the nature of a flat disk-like wedge having two oppositely disposed legs mounted between the diaphragm and an interior wall of the regulator body so as to add a friction force that opposes the movement of the diaphragm.

### SUMMARY OF INVENTION

A stabilizer/fluctuation damper for fluid pressure regulators comprising a friction-creating resilient bias member which mounts upon or is otherwise made part of the actuating linkage (e.g., pivoting lever arm assembly) that connects the pressure-sensing member, e.g., the diaphragm component, to the inlet flow-throttling valve mechanism and frictionally engages the valve body as the linkage/lever system moves, thereby creating a force which opposes such motion and acts to smooth-out oscillation or other fluctuation otherwise present in the mechanism involved, including the throttle valve, and thereby reduce flow fluctuations which would otherwise occur during regulator action.

First and second embodiments of the invention are disclosed and illustrated, each of which in effect comprise spring clips which are readily attachable to the diaphragm/valve linkage, e.g., the pivotal lever or other such mechanism, requiring only minimal component expense and also minimal additional assembly time, and having no physical attachment to the regulator body itself.

### BRIEF DESCRIPTION OF THE DRAWINGS

FIG. 1 is an isometric view showing a first embodiment of the invention;

FIG. 2 is an overhead plan view of the embodiment shown in FIG. 1;

FIG. 3 is a front elevational view of the first embodiment;

FIG. 4 is a side elevational view of the first embodiment;

FIG. 5 is an isometric view showing a second embodiment of the invention;

FIG. 6 is a top plan view of the embodiment shown in FIG. 5;

FIG. 7 is a cross-sectional view taken along the plane VII-VII of FIG. 6;

FIG. 8 is a cross-sectional view taken along the plane VIII-VIII of FIG. 6;

FIG. 9 is a side elevational view of the FIG. 5 embodiment;

FIG. 10 is a cross-sectional view taken along the plane X-X of FIG. 6;

FIG. 11 is a fragmentary, cross-sectional assembly view showing the first embodiment installed in operating position on the actuation lever in a regulator body;

FIG. 12 is a fragmentary, cross-sectional assembly view showing the second embodiment installed in operating position on an actuation lever in a regulator body; and

FIG. 13 is a fragmentary perspective view showing the first embodiment installed in operating position on an actuation lever in a regulator body from an angle different than that of FIG. 11.

### DESCRIPTION OF PREFERRED EMBODIMENTS

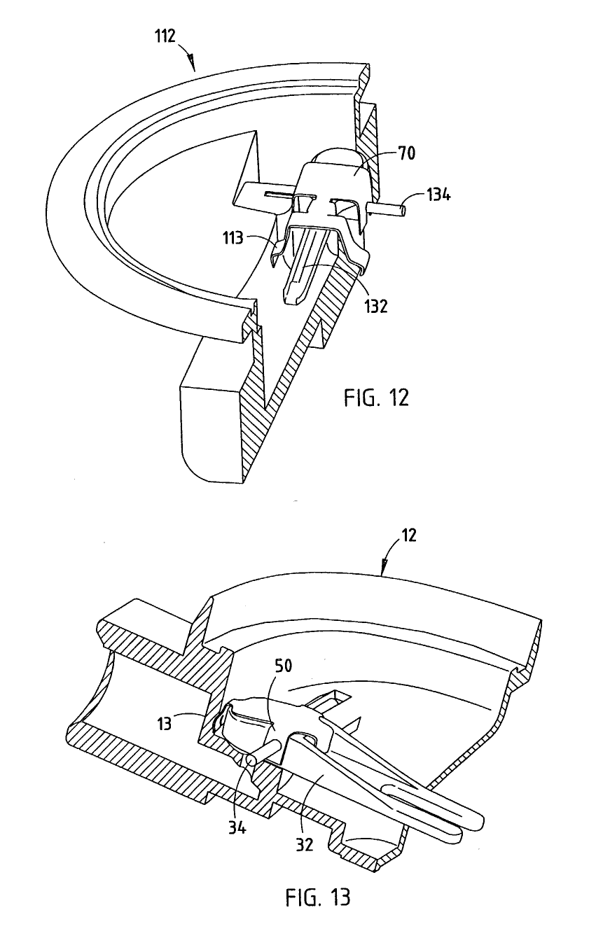

With reference to FIG. 11, a basic regulator structure 10 is illustrated for general reference and as an example of the general type of device involved here. As will be understood, regulator 10 includes a lower body 12 having an inlet 14, an outlet 16, and an open circular top which is closed by an upper body 18 secured in place atop the lower body 12 so as to clamp a diaphragm 20 therebetween in mutually sealed relationship. Diaphragm 20 is biased downwardly by a spring 22 acting against the top of the diaphragm, which is made adjustable by a threaded plug 24 or the like seated in an upstanding turret 26 which is part of upper body 18. A dust cap 28 is preferably mounted atop turret 26 to keep extraneous matter out of the latter. A stem-like actuator 30 is secured to the bottom center or diaphragm 20 to move upwardly and downwardly with it, and thereby apply corresponding movement to one end portion of an actuating lever 32, which is pivotally mounted inside lower body 12 by a pin 34. The end portion of lever 32 opposite actuator 30 carries a sealing disk 36 which controls the amount of gas allowed to flow from inlet 14 through an orifice 38 into lower body 12 and out of outlet 16, passing through the lower diaphragm chamber 40. Insofar as basic regulator aspects are concerned, the showing of FIG. 11 is applicable to both embodiments of the invention disclosed in this patent, and thus apply to the structure shown in FIGS. 12 and 13 as well.

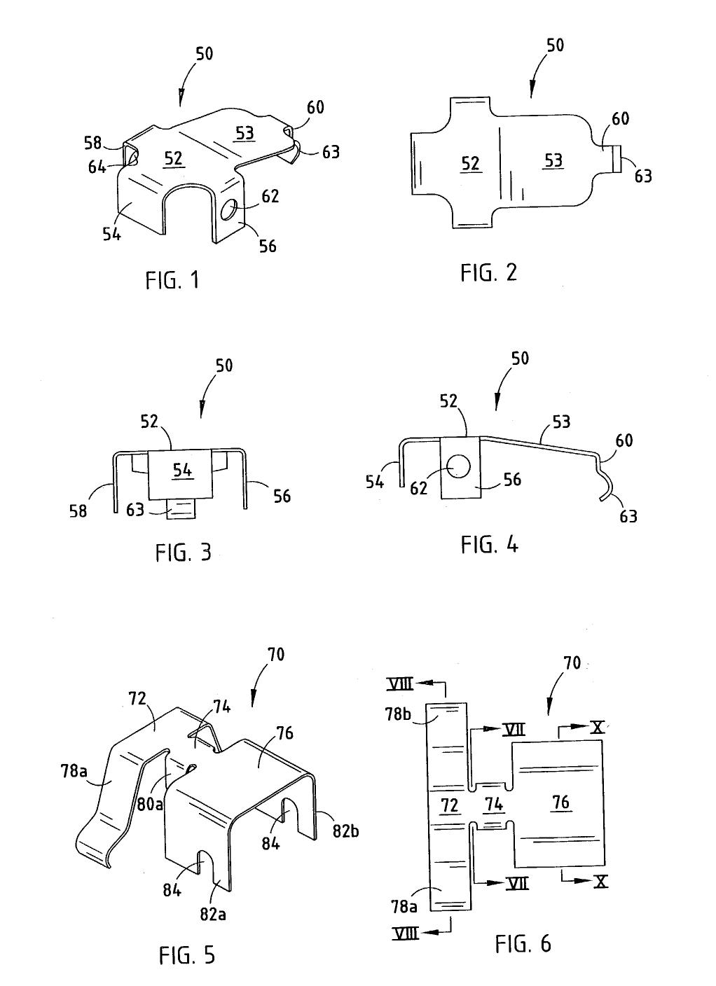

The first embodiment of a stabilizer element 50 in accordance with the invention is shown in detail in FIGS. 1-4 inclusive, and comprises a sheet-metal member having center body portions 52, 53, and four legs 54, 56, 58, and 60 which depend downwardly from the center portions 52, 53, as illustrated. Legs 56 and 58 each have a circular hole 62, 64, respectively, extending through them, which are aligned with one another longitudinally and adapted to receive the pivot pin 34 (FIG. 11) that mounts actuating lever 32 when the stabilizer 50 is mounted atop this lever 32 in the intended position.

The second embodiment 70 of the novel stabilizer provided herewith is illustrated in detail in FIGS. 5-10 inclusive, and is shown mounted in place upon the actuating lever 32 of the regulator body 112 shown in FIG. 12, which may be considered to be substantially the same as the regulator body described above, actuating lever 132 also being substantially the same as lever 32 of FIG. 11 described above.

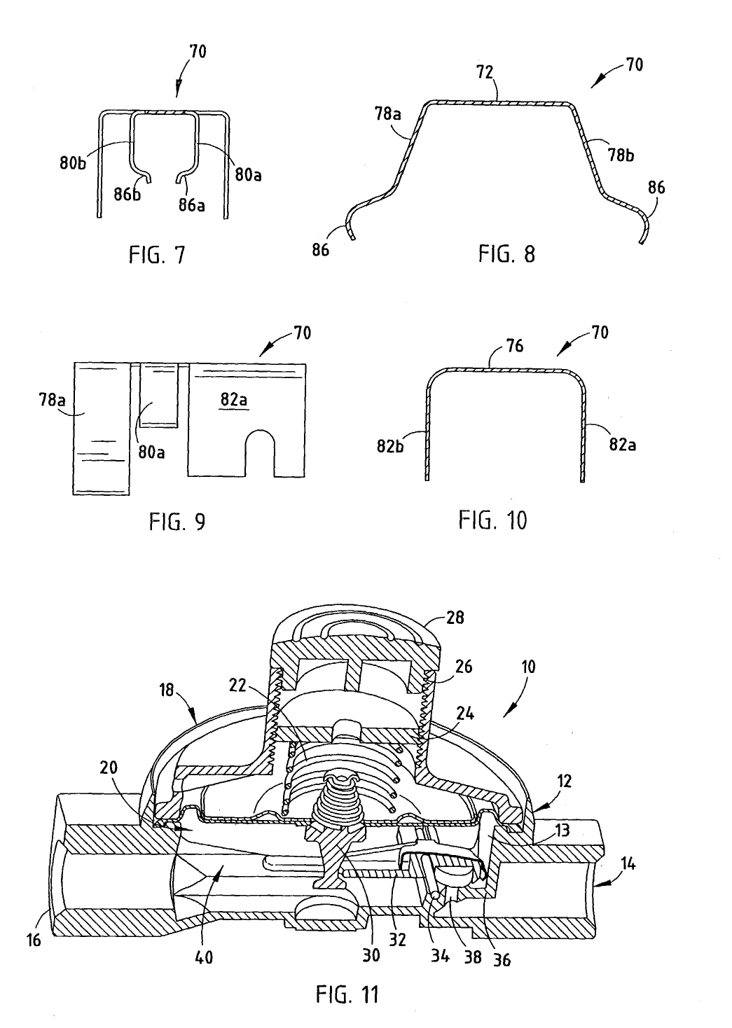

Stabilizer 70 is similar in a number of ways to stabilizer 50, described above in detail, having a central body which includes portions 72, 74, and 76, with a series of downwardly depending legs or arms 78a, 78b, 80a, 80b, and 82a, 82b. Legs 82a and 82b each carry a slot 84 which is generally analogous to the holes 66, 68 shown in stabilizer embodiment 50 and discussed previously, i.e., they are aligned with one another and adapted to receive the pivot pin 134, but in this case slots 84 mount-over and upon the pivot pin by sliding downward atop the actuating lever 132 and over pin 134, as shown in FIG. 12, with the sides of slots 84 straddling pin 134. For this reason, the inner end of each slot 82a, 82b is rounded (“radiussed”) to fit closely around the top of pivot pin 134. Downwardly depending legs 80a, 80b are particularly shown in FIG. 7 wherein it will be seen that the lower extremities of these legs form hooking portions 86a, 86b which are sized and shaped to clamp around the lower side (bottom) of actuating lever 132, so as to hold the stabilizer 70 in place thereupon in a secure manner without any other fastening means.

Downwardly depending legs 78a and 78b of stabilizer embodiment 70 extend angularly away from their associated center body portion 72, as best seen in FIG. 8. Each lower end of legs 78a and 78b is preferably formed into a rounded lower extremity 86, for purposes pointed out subsequently.

Both the first and second stabilizer embodiments 50 and 70 may advantageously be fabricated from sheet metal, preferably 302/304 SST, ASTMA666, half-hard, and may be on the order of 0.010 inches thick (12 gauge). Other materials may be also be made to operate satisfactorily. As noted above and illustrated in FIGS. 11, 12 and 13, the stabilizers 50 and 70 are sized and shaped to be received closely over the top surface of actuating levers 32, 132, (in whatever specific cross section those parts may be given for best serving their intended function under specified operating conditions and configurations). Each such embodiment is completely self-retaining, as noted above, either by being pinned through by the actuating lever pivot pin or by resiliently clamping around the outside of the actuating lever.

Operationally, each of the stabilizer embodiments 50, 70 has one or more resiliently flexible arm or leg portions (60, or 78a, 78b), which is sized and shaped to frictionally engage an adjacent interior wall 13, 113 of the lower body 12, 112, as illustrated in FIGS. 11, 12 and 13. Specifically, the legs/arm portions 60 and 78a, 78b constitute spring arms, and each have rounded lower extremities 63, 86 that are spring-biased against the adjacent surface 13, 113 of the lower regulator body or other structure to produce the desired friction force therebetween upon movement of the regulator actuating lever 32, 132. That is, the spring arms 60 and 78a, 78b are in their as-manufactured configuration made to occupy a position at least somewhat further away from the actuating lever when mounted thereupon than would be necessary to merely place their outer surface contiguous to the adjacent regulator body wall, thus requiring that they be resiliently deflected somewhat in order to fit into the allowable space for them. This of course applies a spring loading to their contact with the regulator body wall, producing a loading force.

In the foregoing regard, an example of a typical such resilient deflection for spring arms 60 and 78a, 78b may be on the order of from about 0.010 to 0.020 inch, for a configuration and implementation such as that described above, which produces an ample damping force for a typical application. Of course, as already noted, this force may readily be adjusted by changing the angulation (and thus spacing) of the spring arms with respect to the adjacent body wall, and also by changing dimensions or material selection for the sheet stock from which they are made, to make them more or less stiff. As will be recognized, the rounded lower extremity of the spring arms provides a smooth moving contact between these arms and the adjacent body wall against which they frictionally bear during regulator operation. Thus, the specific curvature and extent of these rolled edges is therefore not a critical matter, although their presence is very useful in their operation.

As will be understood from consideration of the foregoing disclosure, the present invention provides a unique new type and form of stabilizer for fluid regulators, particularly gas regulators, which is economical and easy to manufacture while at the same time being simple and fast to install during assembly. The new stabilizer permits easy adjustment to vary the amount of frictional force which it provides with respect to the regulator body, by adjusting the spring arm portions inwardly or outwardly and/or using different types of materials which have different physical properties, and/or using different cross sections or other dimensions which correspondingly change the forces produced. The sliding engagement against the wall of the regulator body (which is contemplated as being smooth and flat or otherwise-shaped to accommodate the friction leg travel during regulator operation) is continuous, steady and smooth, being constantly applied at any position of actuating lever movement and thereby serving to smooth out (damp) undesired regulator component movements that would otherwise be applied to the throttle-valve which controls the inlet flow of fluid into the regulator. A significant advantage of the embodiments shown is that they are each so readily mounted in place during assembly, requiring no attachment to the regulator body or any other component, apart from the “snap-on” assembly operation described above. It is further contemplated that the stabilizer elements 50, 70 could be integral with the actuating levers 32, 132, with spring arms 60 and 78a, 78b extending from the actuating levers 32, 132.

It is believed that the significant advantages provided by the present invention will be apparent to and appreciated by those skilled in the art upon consideration of the foregoing disclosure, and it is to be noted once again that an underlying concept is advanced which is specifically different from those addressed by the prior state of the art, notwithstanding the superficially similar attributes. It is to be understood that the foregoing detailed description is merely that of certain exemplary preferred embodiments of the invention, and that numerous changes, alterations and variations may be made without departing from the underlying concepts and broader aspects of the invention as set forth in the appended claims, which are to be interpreted in accordance with the established principles of patent law, including the doctrine of equivalents.

1. A pressure regulator comprising:
a housing having an inlet port and an outlet port;
a pivoting lever selectively covering a section of a passage between the inlet port and the outlet port;
a diaphragm interconnected to the pivoting lever to rotate the lever in reaction to pressure levels in the housing; and
a stabilizer element movable with the pivoting lever, the stabilizer element frictionally abutting a portion of the housing as the pivoting lever rotates to thereby stabilize movement of the pivoting lever.

2. The pressure regulator of claim 1, wherein:
the stabilizer element comprises a part separate from the pivoting lever and connected thereto.

3. The pressure regulator of claim 2, wherein:
the stabilizer element includes at least one flexible projection; and
the at least one flexible projection frictionally abuts the portion of the housing.

4. The pressure regulator of claim 3, wherein:
the at least one flexible projection comprises a spring arm having a rounded lower extremity.

5. The pressure regulator of claim 4, wherein:
the pivoting lever has an axis of rotation; and
the spring arm extends from the pivoting lever in a direction perpendicular to the axis of rotation of the pivoting lever.

6. The pressure regulator of claim 5, wherein:
the at least one flexible projection comprises a pair of spring arms.

7. The pressure regulator of claim 6, wherein:
the pivoting lever has an axis of rotation; and
the pair of spring arms extend from opposite sides of the pivoting lever in a direction parallel to the axis of rotation of the pivoting lever.

8. The pressure regulator of claim 7, wherein:
the spring arms have rounded lower extremities.

9. The pressure regulator of claim 2, wherein:
a pivot pin pivotally connects the pivoting lever to the housing;
the stabilizer element includes a pair of legs straddling the pivoting lever, each one of the pair of legs having an aligned hole accepting the pivot pin therein to thereby connect the stabilizer element to the pivoting lever.

10. The pressure regulator of claim 2, wherein:
the stabilizer element includes a pair of legs straddling the pivoting lever, the pair of legs each including hooking portions which are sized and shaped to clamp around a lower side of the pivoting lever to thereby connect the stabilizer element to the pivoting lever.

11. The pressure regulator of claim 1, wherein:
the stabilizer element includes at least one flexible projection; and
the at least one flexible projection frictionally abuts the portion of the housing.

12. The pressure regulator of claim 11, wherein:
the at least one flexible projection comprises a spring arm having a rounded lower extremity.

13. The pressure regulator of claim 12, wherein:
the pivoting lever has an axis of rotation; and
the spring arm extends from the pivoting lever in a direction perpendicular to the axis of rotation of the pivoting lever.

14. The pressure regulator of claim 11, wherein:
the at least one flexible projection comprises a pair of spring arms.

15. The pressure regulator of claim 14, wherein:
the pivoting lever has an axis of rotation; and
the pair of spring arms extend from opposite sides of the pivoting lever in a direction parallel to the axis of rotation of the pivoting lever.

16. The pressure regulator of claim 15, wherein:
the spring arms have rounded lower extremities.

17. A pressure regulator comprising:
a housing having an inlet port and an outlet port;
a pivoting lever selectively covering a section of a passage between the inlet port and the outlet port;
a diaphragm located in the housing;
a stem connected to the pivoting lever and the diaphragm, the stem pivoting the pivoting lever to close the section of the passage when pressure within the housing forces the diaphragm to move; and
a stabilizer element connected to the pivoting lever, the stabilizer element having at least one flexible projection frictionally abutting a portion of the housing as the pivoting lever rotates, thereby stabilizing movement of the pivoting lever.

18. The pressure regulator of claim 17, wherein:
the at least one flexible projection comprises a spring arm having a rounded lower extremity.

19. The pressure regulator of claim 18, wherein:
the pivoting lever has an axis of rotation; and
the spring arm extends from the pivoting lever in a direction perpendicular to the axis of rotation of the pivoting lever.

20. The pressure regulator of claim 17, wherein:
the at least one flexible projection comprises a pair of spring arms.

21. The pressure regulator of claim 20, wherein:
the pivoting lever has an axis of rotation; and
the pair of spring arms extend from opposite sides of the pivoting lever in a direction parallel to the axis of rotation of the pivoting lever.

22. The pressure regulator of claim 21, wherein:
the spring arms have rounded lower extremities.

23. The pressure regulator of claim 17, wherein:
a pivot pin pivotally connects the pivoting lever to the housing;
the stabilizer element includes a pair of legs straddling the pivoting lever, each one of the pair of legs having an aligned hole accepting the pivot pin therein to thereby connect the stabilizer element to the pivoting lever.

24. The pressure regulator of claim 17, wherein:
the stabilizer element includes a pair of legs straddling the pivoting lever, the pair of legs each including hooking portions which are sized and shaped to clamp around a lower side of the pivoting lever to thereby connect the stabilizer element to the pivoting lever.

25. A pressure regulator comprising:
a housing having an internal chamber, an inlet port fluidly connected to the internal chamber and an outlet port fluidly connected to the internal chamber;
a diaphragm dividing the internal chamber into a lower chamber and an upper chamber;
a pivoting lever located in the internal chamber and pivotally connected to the housing, the pivoting lever having a first position wherein a portion of the pivoting lever covers a section of the internal chamber, thereby stopping fluid flow between the inlet port and the outlet port, the pivoting lever having a second position wherein the portion of the pivoting lever does not cover the section of the internal chamber and allows fluid flow between the inlet port and the outlet port;
a stem connected to the pivoting lever and the diaphragm, the stem pivoting the pivoting lever towards the first position to close the section of the internal chamber when pressure within lower chamber rises above a predetermined level;
a biasing element engaging the diaphragm to bias the pivoting lever towards the second position; and
a stabilizer element connected to the pivoting lever, the stabilizer element having at least one flexible projection frictionally abutting a portion of the housing as the pivoting lever pivots, thereby stabilizing movement of the pivoting lever.

26. The pressure regulator of claim 25, wherein:
the stabilizer element includes at least one flexible projection; and
the at least one flexible projection frictionally abuts the portion of the housing.

27. The pressure regulator of claim 26, wherein:
the at least one flexible projection comprises a spring arm having a rounded lower extremity.

28. The pressure regulator of claim 27, wherein:
the pivoting lever has an axis of rotation; and
the spring arm extends from the pivoting lever in a direction perpendicular to the axis of rotation of the pivoting lever.

29. The pressure regulator of claim 25, wherein:
the at least one flexible projection comprises a pair of spring arms.

30. The pressure regulator of claim 29, wherein:
the pivoting lever has an axis of rotation; and
the pair of spring arms extend from opposite sides of the pivoting lever in a direction parallel to the axis of rotation of the pivoting lever.

31. The pressure regulator of claim 30, wherein:
the spring arms have rounded lower extremities.

32. The pressure regulator of claim 25, wherein:
a pivot pin pivotally connects the pivoting lever to the housing;
the stabilizer element includes a pair of legs straddling the pivoting lever, each one of the pair of legs having an aligned hole accepting the pivot pin therein to thereby connect the stabilizer element to the pivoting lever.

33. The pressure regulator of claim 25, wherein:
the stabilizer element includes a pair of legs straddling the pivoting lever, the pair of legs each including hooking portions which are sized and shaped to clamp around a lower side of the pivoting lever to thereby connect the stabilizer element to the pivoting lever.
